(19) United States
(12) Patent Application Publication
(10) Pub. No.: US 2019/0261821 A1
(43) Pub. Date: Aug. 29, 2019

(54) ABSORBENT MAT

(71) Applicant: Principle Business Enterprises, Inc., Dunbridge, OH (US)

(72) Inventors: Erin Johnson, Perrysburg, OH (US); Adam Strizzi, Perrysburg, OH (US); Andrew J. Szypka, Curtice, OH (US); Blake Miller, Temperance, MI (US)

(21) Appl. No.: 16/230,177

(22) Filed: Dec. 21, 2018

Related U.S. Application Data
(60) Provisional application No. 62/634,713, filed on Feb. 23, 2018.

(51) Int. Cl. A47K 17/02; B32B 3/16; B32B 7/12

(52) U.S. Cl. CPC A47K 17/02; B32B 3/16; B32B 2471/04; B32B 2307/726; B32B 7/12

(57) ABSTRACT

An absorbent mat includes a composite absorbent sheet with an absorbent layer, an intermediate adhesive layer, and a protective layer. The intermediate adhesive layer is affixed to the absorbent layer. The protective layer has a predetermined split defining a plurality of protective portions. Each of the protective portions are removably attached to the intermediate adhesive layer. The absorbent mat has a free peripheral edge that is not bounded or otherwise captured by a frame. The absorbent mat also has a dry edge area disposed adjacent the peripheral free edge of the absorbent layer. The dry edge area is defined by the absence of significant adhesion between the protective layer and the intermediate adhesive layer.

### CROSS REFERENCE TO RELATED APPLICATIONS

This application claims the benefit of U.S. Provisional Application Ser. No. 62/634,713, filed on Feb. 23, 2018. The entire disclosure of the above application is hereby incorporated herein by reference.

### FIELD

The disclosure generally relates to absorbent mats and, more particularly, to a frameless floor mat for placement beneath urinals and commodes in restrooms.

### BACKGROUND

It is known in the art to maintain sanitary conditions in restrooms near toilets and wall-mounted urinals using trays, mats, or sheets. This is especially the case in public restrooms where unwanted moisture, odor and bacteria on the floors commonly present sanitary and aesthetic problems and potential safety risks.

For example, U.S. Pat. No. 4,125,656 to Creamer shows a pleated absorbent sheet for use around the base of a pedestal toilet to absorb moisture. Undesirably, the pleated Creamer sheet is small and only suitable to absorb condensation dripping down the sides of the pedestal of a toilet. As such, it is not suitable for use at a wall-mounted urinal. The Creamer sheet also does not aid in collecting drips or spills attributable to the user himself, or the flushing action, condensation, or any other occurrence causing liquid to pool underneath the urinal. The time-consuming and complicated pleating, folding, and adjustment features of the Creamer sheet further reduce its usefulness.

Other known absorbent sheets are designed to be held within bulky, rigid trays or frames. These trays themselves are known to collect moisture and unsanitary bacteria, and likewise can malodorous. They are also expensive to manufacture, creating a hesitancy for consumers to dispose of the soiled tray. Also, the trays are usually unattractive, especially after extended use. Thus, they usually do not reduce cleaning time, nor do they necessarily provide the desired improved sanitary environment.

One further concern with known absorbent sheets is the risk of the sheet slipping out of position while in use. Again, unsatisfactory attempts to prevent this problem have been made. Some products secure a sheet or a collection of sheets through use of strings, tape, or staples. These additional materials make the sheets both more difficult to manufacture, and more time-consuming to install and remove. For example, U.S. Pat. No. 2,057,162 to Richey utilizes strings to tie absorbent sheets to toilet pedestals. Not only is the Richey sheet difficult to install, but it is also unsanitary since the attendant must reach behind the toilet to install the sheet.

There is a continuing need for an absorbent mat for use in restrooms and elsewhere underneath urinals and commodes. Desirably, the absorbent mat is inexpensive, foldable, easy to install, and easy to remove.

### SUMMARY

In concordance with the instant disclosure, an absorbent mat for use in restrooms and elsewhere underneath urinals and commodes, and which is inexpensive, foldable, easy to install, and easy to remove, has been surprisingly discovered.

In one embodiment, an absorbent mat includes an absorbent layer, a protective layer, and an intermediate adhesive layer. The absorbent layer has a first section and a second section. At least one folding axis separates the first section from the second section. The absorbent layer further has a peripheral free edge that bounds the first section and the second section. The intermediate adhesive layer is affixed to the absorbent layer and disposed between the absorbent layer and the protective layer. The protective layer is removably attached to the intermediate adhesive layer. The intermediate adhesive layer further has a dry edge area disposed adjacent the peripheral free edge of the absorbent layer. There is no significant adhesion between the dry edge area and the protective layer.

In another embodiment, an absorbent mat for a urinal includes an absorbent layer, a protective layer, and an intermediate adhesive layer. The absorbent layer has a first section and a second section. At least one folding axis separates the first section from the second section. The absorbent layer further has a peripheral free edge that bounds the first section and the second section. The peripheral free edge of the first section has a first side edge, a second side edge, and a front edge. The first side edge is angled generally toward the second side edge, and the second side edge is angled generally toward the first side edge. The front edge connects the first side edge to the second side edge. The peripheral free edge of the second section has a rear edge that is spaced apart from and disposed opposite on the absorbent layer from the front edge. The intermediate adhesive layer is affixed to the absorbent layer. The protective layer is removably attached to the intermediate adhesive layer. The protective layer has at least one split that defines a plurality of protective portions of the protective layer. Each of the protective portions is removably attached to the intermediate adhesive layer. The intermediate adhesive layer further has a dry edge area disposed immediately adjacent to the rear edge of the second section of the absorbent layer. There is no significant adhesion between the dry edge area and the protective layer. The absorbent mat is configured to be placed adjacent to the urinal. More particularly, the second section of the absorbent layer is configured to be placed beneath the urinal.

In a further embodiment, an absorbent mat for a commode includes an absorbent layer, a protective layer, and an intermediate adhesive layer. The absorbent layer has a first section and a second section. At least one folding axis separates the first section from the second section. The absorbent layer further has a peripheral free edge that bounds the first section and the second section. The peripheral free edge of the first section has a front edge, and the peripheral free edge of the second section has a rear edge spaced apart from and disposed opposite on the absorbent layer from the front edge. The absorbent layer is generally U-shaped with the first section including a first arm and a second arm. The first arm is spaced apart from the second arm and a gap is formed therebetween. The intermediate adhesive layer is affixed to the absorbent layer. The protective layer is removably attached to the intermediate adhesive layer. The protective layer has at least one split that defines a plurality of protective portions of the protective layer. Each of the protective portions is removably attached to the intermediate adhesive layer. The intermediate adhesive layer further has a dry edge area disposed immediately adjacent to the rear edge of the second section of the absorbent layer. There is no significant adhesion between the dry edge area and the protective layer. The absorbent mat is configured to be placed adjacent to the commode. The second section of the absorbent layer is configured to be placed in front of a base of the commode and the gap is configured to receive the base of the commode.

### DRAWINGS

The above, as well as other advantages of the present disclosure, will become readily apparent to those skilled in the art from the following detailed description, particularly when considered in the light of the drawings described hereafter.

FIG. 1 is a top plan view of an absorbent mat according to one embodiment of the present disclosure, and the absorbent mat adapted for use below a urinal;

FIG. 2 is a bottom plan view of the absorbent mat shown in FIG. 1, and illustrating a peel-away protective layer having a first portion and a second portion separated by a split formed in the protective layer;

FIG. 3 is a bottom plan view of the absorbent mat shown in FIG. 2, and showing the first portion of the protective layer being partly peeled away at a dry edge area of the absorbent mat to expose an underlying adhesive layer;

FIG. 4 is a bottom plan view of the absorbent mat shown in FIG. 2, and showing the second portion of the protective layer being partly peeled away at the split to expose the underlying adhesive layer;

FIG. 5 is a top perspective view of the absorbent mat shown in FIGS. 1-4, where the absorbent mat is disposed below the urinal;

FIG. 6 is a top plan view of the absorbent mat according to another embodiment of the present disclosure, and the absorbent mat adapted for use adjacent a commode,

FIG. 7 is a bottom plan view of the absorbent mat shown in FIG. 6, and illustrating a peel-away protective layer having a first portion and a second portion separated by a split formed in the protective layer;

FIG. 8 is a bottom plan view of the absorbent mat shown in FIG. 7, and showing the first portion of the protective layer being partly peeled away at a dry edge area of the absorbent mat to expose an underlying adhesive layer;

FIG. 9 is a top perspective view of the absorbent mat shown in FIGS. 6-8, where the absorbent mat is disposed adjacent the commode;

FIG. 10 is a top perspective view of the absorbent mat according to the embodiment shown in FIGS. 1-5, where the absorbent mat is being folded and placed into a box for storage and transport;

FIG. 11 is a top perspective view of the absorbent mat according to the embodiment shown in FIGS. 6-9, where the absorbent mat is being folded and placed into a box for storage and transport;

FIG. 12 is an enlarged, fragmentary, top plan view of an absorbent layer of the absorbent mat taken at callout A in FIGS. 1 and 6, and illustrating a mark- and wear-resistant pattern formed on an outer surface of the absorbent layer;

FIG. 13 is a fragmentary, cross-sectional, side elevational view of the absorbent mat taken at section-line B-B in FIGS. 1 and 6, and illustrating the dry edge area of the absorbent mat;

FIG. 14 is a fragmentary, cross-sectional, front elevational view of the absorbent mat taken at section-line C-C in FIGS. 1 and 6, and illustrating an embossed edge crimping pattern according to one embodiment of the present disclosure, the crimping pattern adapted to minimize delamination of edges of the absorbent mat;

FIG. 15 is a fragmentary, cross-sectional, front elevational view of the absorbent mat taken at section-line C-C in FIGS. 1 and 6, and illustrating an angled edge crimping pattern according to another embodiment of the present disclosure, the crimping pattern adapted to minimize delamination of edges of the absorbent mat; and

FIG. 16 is a fragmentary, cross-sectional, front elevational view of the absorbent mat taken at section-line C-C in FIGS. 1 and 6, and illustrating a stepped edge crimping pattern according to an additional embodiment of the present disclosure, the crimping pattern adapted to minimize delamination of edges of the absorbent mat.

### DETAILED DESCRIPTION

The following description is merely exemplary in nature and is not intended to limit the present disclosure, application, or uses. It should also be understood that throughout the drawings, corresponding reference numerals indicate like or corresponding parts and features. In respect of the methods disclosed, the order of the steps presented is exemplary in nature, and thus, is not necessary or critical unless otherwise disclosed.

An absorbent mat 2 for use with urinals or commodes is shown in FIGS. 1-16. The absorbent mat 2 includes a composite absorbent sheet having an absorbent layer 4, an intermediate adhesive layer 6, and a protective layer 8. The absorbent mat 2 has a free peripheral edge 10, which is not bounded or otherwise captured by a frame. Thus, the absorbent mat 2 of the present disclosure is more hygienic, cost-effective, and environmentally-friendly relative to framed urinal mats known in the art.

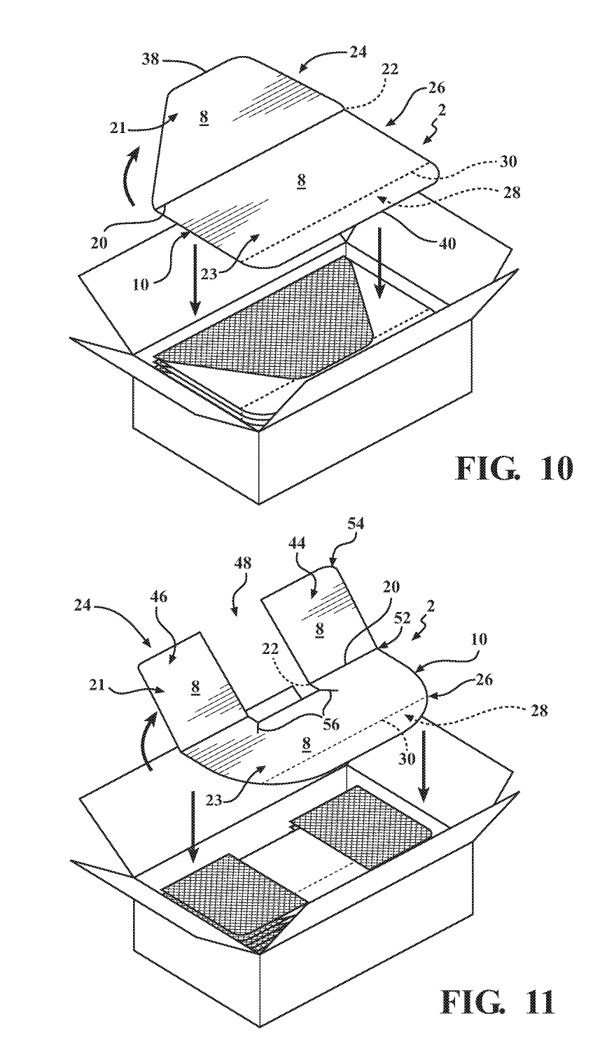

Although described primarily herein as a discrete unit, for example, that may be folded and stored or shipped in a box as shown in FIGS. 10-11, the absorbent mat 2 may alternatively be provided as one of a plurality of absorbent mats 2 in a roll that can be cut by a user to a desired size or length.

Advantageously, the absorbent layer 4 is configured to repeatedly absorb fluids, such as water or urine, that may be splashed onto the absorbent mat 2 in operation. The absorbent mat 2 is adapted to absorb fluids without becoming undesirably slippery, tearing, or degrading quickly with repeated use adjacent urinals and commodes.

In particular embodiments, the absorbent layer 4 may be formed from a non-woven textile material. For example, the absorbent layer 4 may be formed from a bonded polyester such as Magic Dragon™ (MD) 100-series nonwoven material. MD 100-series nonwoven material is a disposable non-woven textile comprised primarily of rayon, polyester and a binding agent, which is produced in bulk rolls for sale to third-party distributors by Sellars Absorbent Materials, Inc.

It has surprisingly been found that the MD 100-series of nonwoven materials is particularly suitable for the absorbent layer 4, due to their superior flexibility and resistance to degradation relative to other known materials. The MD 100-series has especially been found to be resistant to creasing upon being folded, as established further hereinbelow. In a most particular example, MD 105 nonwoven material may be used. However, one of ordinary skill in the art may also select other suitable materials for the absorbent layer 4, as desired.

The absorbent mat 2 may also have adjuvants for enhanced performance such as, for example, fragrances or odor-absorbing neutralizers like sodium bicarbonate. These materials may be applied to any of the absorbent layer 4, the intermediate adhesive layer 6, and the protective layer 8 of the absorbent mat 2, but in particular examples are embedded or intermixed with the fibers of the non-woven textile forming the absorbent layer 4. The adjuvants may also be added neat to one or more of the absorbent layer 4, the intermediate adhesive layer 6, and the protective layer 8 during assembly of the absorbent mat 2. The adjuvants may exist within the absorbent mat 2 in separate or distinct layers. Additionally, various antimicrobial compounds may be added to the absorbent layer 4, or to the intermediate adhesive layer 6 and the protective layer 8, as desired.

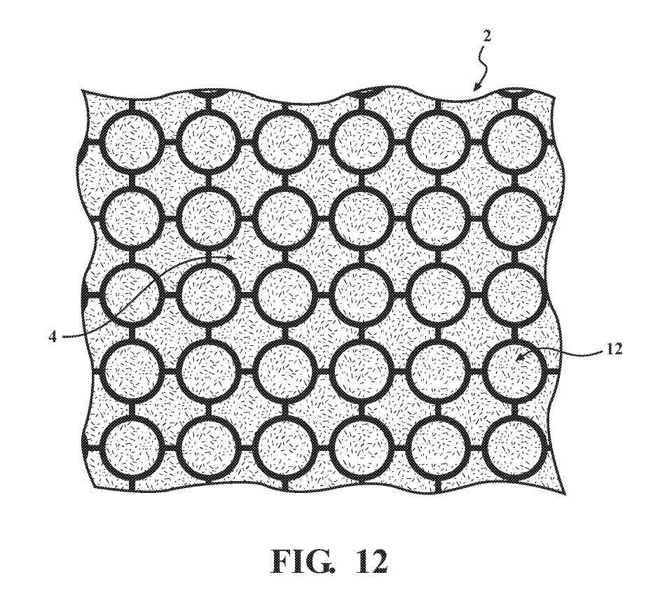

An upper surface of the absorbent layer 4 may also be provided with a mark- and wear-resistant pattern 12, for example, as shown in FIG. 12. The mark- and wear-resistant pattern 12 may be printed with ink or embossed onto the upper surface, for example. In particular embodiments, the mark- and wear-resistant pattern 12 may be defined by a plurality of geometric elements connected by lines in a grid-like pattern across the upper surface of the absorbent layer 4. In a most particular embodiment, the geometric elements are circles or ovals, which may have a diameter between about ¼ inches and ½ inches, and most particularly about ⅜ inches, as non-limiting examples. The pattern 12 is preferably of a darker color or shade than the remainder of the absorbent layer 4. For example, the pattern 12 may be provided as black against a gray background of the remainder of the absorbent layer 4. In another example, the pattern 12 may be of a lighter color against a darker color or shade of the remainder of the absorbent layer 4. In both cases, the contrast in shade or color is believed to minimize the visibility of splash marks on the upper surfaces.

It has been found that the use of circles or ovals as geometric elements in a grid-like pattern, connected with lines, is particularly useful for minimizing the visibility of splash marks on the upper surface. However, of ordinary skill in the art may select other suitable arrangements, geometric elements, and coloration for the pattern 12 within the scope of the present disclosure.

It should be appreciated that the mark- and wear-resistant pattern 12 may also be selected for purpose of maintaining aesthetics of the upper surface with repeated use at urinals and commodes. In certain examples, the mark- and wear-resistant pattern 12 may also provide an anti-slipping quality to the upper surface of the absorbent layer 4, for example, through use of ink with polymers or additives such as a silica grit that enhances the texture and grip of the upper surface of the absorbent layer 4. In further examples, the mark- and wear-resistant pattern 12 may be a message or an advertisement. Other types of markings for the mark- and wear-resistant pattern 12 may also be employed.

The absorbent layer 4 may also have superabsorbent materials. However, where the superabsorbent materials are used, it should be appreciated that they may be encapsulated or provided as a discrete layer beneath a topmost layer of the absorbent layer 4 to militate against a user slipping on the absorbent mat 2 in operation. For example, the superabsorbent materials may be starch-based, cellulose-based, or synthetic. In a most particular example, the superabsorbent materials are particulates of superabsorbent polymers (SAP) such as sodium polyacrylate. However, one of ordinary skill in the art may select other suitable superabsorbent materials, as desired.

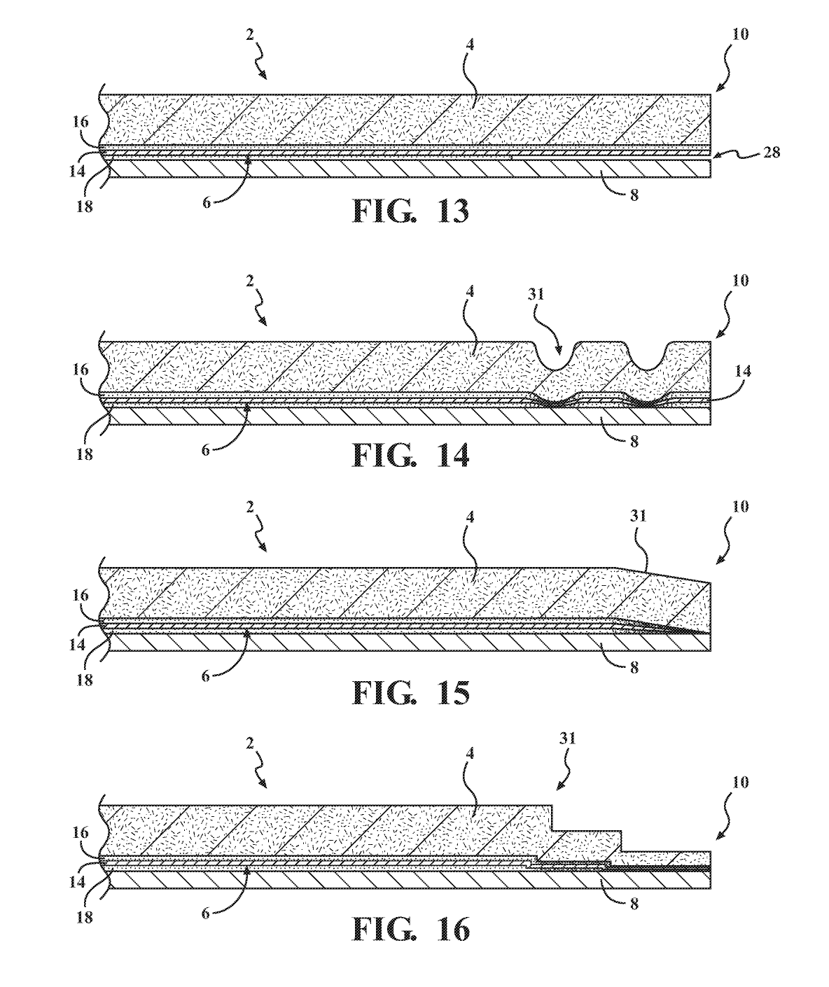

The intermediate adhesive layer 6 of the present disclosure is configured to removably secure the absorbent mat 2 to a floor of a restroom. For example, as shown in FIGS. 13-16, the intermediate adhesive layer 6 may be a laminate including a thin plastic sheet 14 disposed or sandwiched between a first adhesive 16 and a second adhesive 18, for example, a double-sided adhesive tape. It should be appreciated that the plastic sheet 14 of the intermediate adhesive layer 6 militates against fluid seeping through the absorbent layer 4 and onto the floor below. The plastic sheet 14 also militates against a wicking of moisture from the floor into the absorbent layer 4. In a non-limiting example, the plastic sheet 14 may be a polyethylene terephthalate (PET) film, and each of the first adhesive 16 and the second adhesive 18 are formed from an acrylic emulsion adhesive.

In other examples, the intermediate adhesive layer 6 may be sprayed or otherwise applied onto the bottom surface of the absorbent layer 4 to form a discrete layer of adhesive material. In a specific non-limiting example, the intermediate adhesive layer 6 may be formed from a discrete layer of acrylic emulsion adhesive. However, a skilled artisan may also select other suitable adhesives and methods for forming the intermediate adhesive layer 6, as desired.

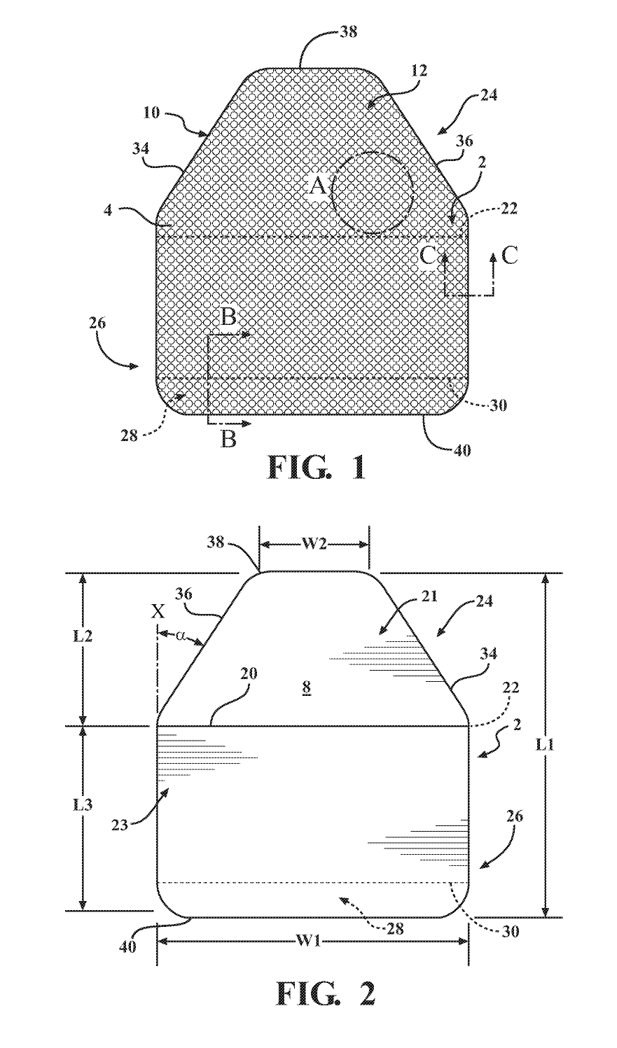

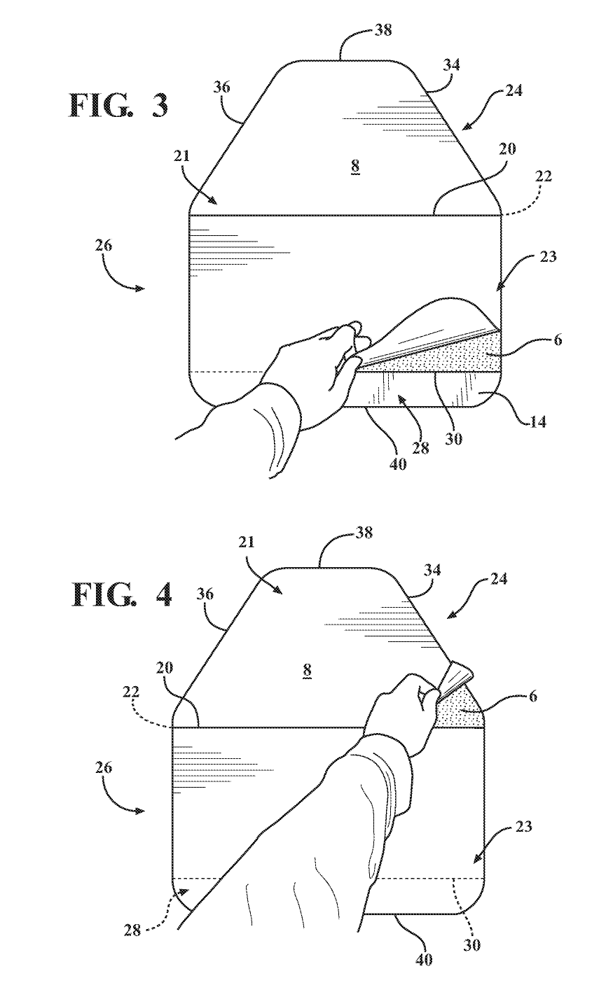

With reference to FIGS. 2-4 and 7-8, the protective layer 8 of the absorbent mat 2 is adapted to cover the adhesive layer 6 until needed for application onto the floor surface. For example, the protective layer 8 may be peeled away by the user prior to application onto the floor surface, as shown in FIGS. 3, 4, and 8. In non-limiting examples, the protective layer 8 may be a wax-paper or a plastic film. In a most particular example, the protective layer 8 may include a silicone-coated craft paper. However, a skilled artisan may also select other suitable materials and methods for forming the protective layer 8, as desired.

The protective layer 8 of the absorbent mat 2 may be divided into more than one portion 21, 23, for example, by a split 20 formed in the protective layer 8. The different portions 21, 23 may be selectively and independent removed from the absorbent mat 2 prior to final disposition at the urinal or commode. For example, the protective layer 8 may be separated by a cut formed therethrough that defines the split 20. In particular, the cut may extend across an entirety of the protective layer 8 from a first side to a second side of the absorbent mat 2. In another example, the split 20 may be defined by a row of perforations formed through the protective layer. It should be appreciated that the split 20 may create a plurality of the protective portions 21, 23 of the protective layer 8, where each of the protective portions 21, 23 is removably attached to the intermediate adhesive layer 6.

As shown in FIGS. 2-4 and 7-8, the split 20 may divide the protective layer 8 into the protective portions 21, 23 including a first protective portion 21 and a second protective portion 23. In certain embodiments, the split 20 may be formed along a folding axis 22 that is oriented transverse to a longitudinal axis X of the absorbent mat 2, where the longitudinal axis X is depicted adjacent a first side of the absorbent mat 2 in FIG. 2. However, one skilled in the art may select any number of splits 20 in the protective layer 8, as well as different orientations for the splits 20, or may divide the protective layer 8 using a variety of suitable methods as known in the art.

Advantageously, the split 20 in the protective layer 8 may facilitate a folding of the absorbent mat 2 along the folding axis 22 in the absorbent layer 4. In certain embodiments, the split 20 may be coplanar with and define the folding axis 22, for example. It should be appreciated that the presence of the split 20 may facilitate the folding of the absorbent layer 4 and the intermediate adhesive layer 6, which otherwise together with the protective layer 8 may have an undesirably rigidity in the absence of the split 20. In particular, it should be appreciated that the split 20 allows the absorbent mat 2 to be easily and manually folded along the folding axis 22 for transport and storage, as shown in FIGS. 10-11.

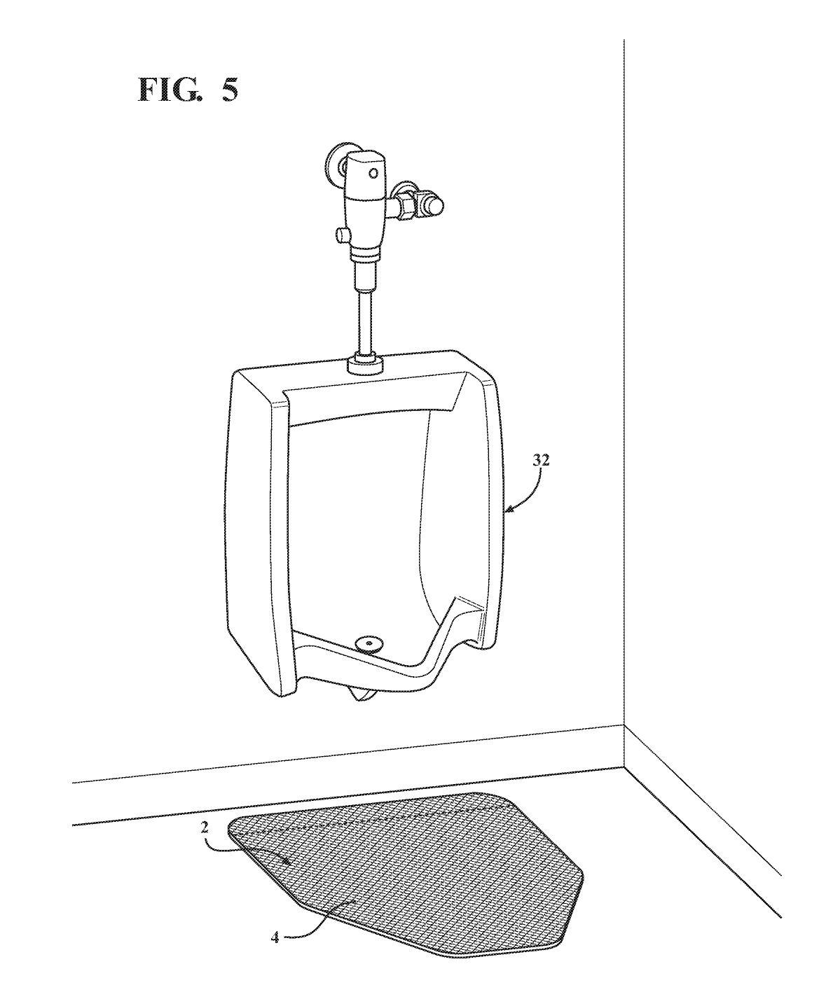

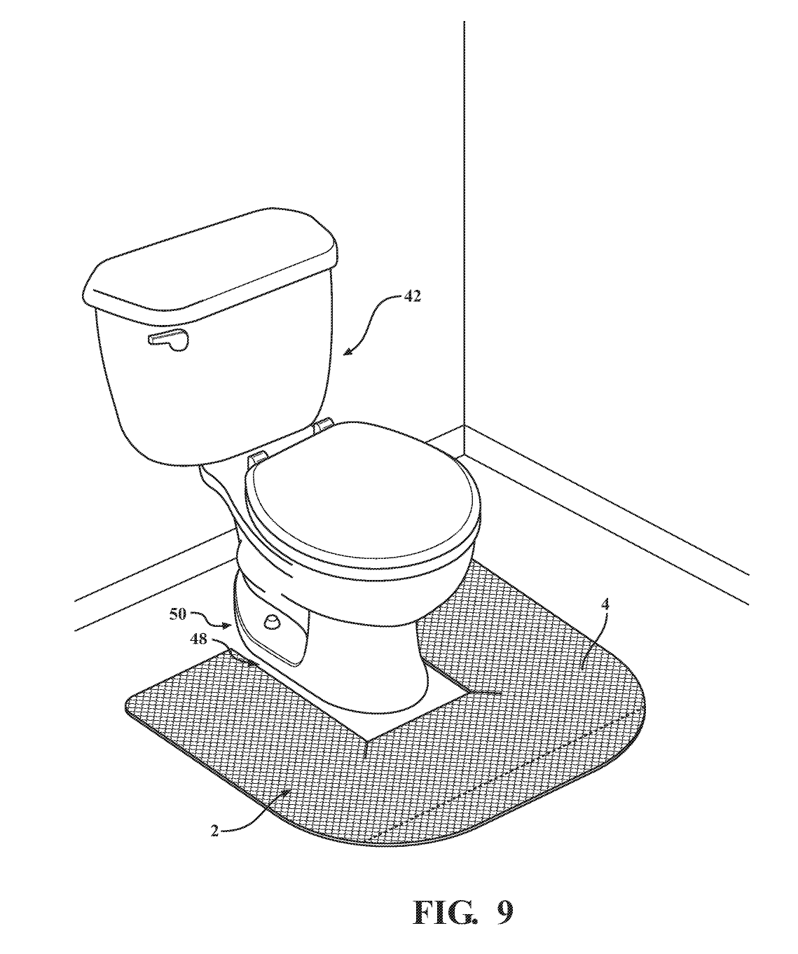

With reference to FIGS. 1-4, 6-8, and 10-11, the absorbent layer 4 may have a first section 24 and a second section 26. The first section 24 and the second 26 may be shaped differently as described further hereinbelow, and according to the intended use of the absorbent mat 2 for either urinals, as shown in FIG. 5, or commodes, as shown in FIG. 9. In certain embodiments, the first section 24 and the second section 26 of the absorbent layer 4 may be divided by the folding axis 22, which may likewise correspond with the location of the split 20.

As shown in FIGS. 3, 8, and 13, the absorbent mat 2 may have a dry edge area 28 disposed adjacent to the peripheral edge 10 on the second section 26 of the absorbent layer 4. The dry edge area 28 results in no significant adhesion between a portion of the protective layer 8 disposed adjacent the dry edge area 28 and the intermediate adhesive layer 6. For example, the dry edge area 28 may be created by failing to apply adhesive to a portion of the absorbent layer 4, or by applying the adhesive to the entire absorbent layer 4 and then removing the adhesive from the dry edge area 28. It should be appreciated that the dry edge area 28 may facilitate a removal of the protective layer 8 from the intermediate adhesive layer 6 for installation, and also provide additional advantages as described further herein.

The dry edge area 28 may disposed adjacent a border 30 of the second adhesive 18, as shown in FIGS. 1-4, 6-8, and 10-11. With reference to FIGS. 3, 8, and 13, where the intermediate adhesive layer 6 includes the laminate of the first adhesive 16, the plastic sheet 14, and the second adhesive 18, the dry edge area 28 may be created by removing the second adhesive 18 from the plastic sheet 14. For example, the second adhesive 18 may be initially applied to the intermediate adhesive layer 6 during the manufacturing process, and then subsequently squeegeed or wiped away from the dry edge area 28 prior to application of the protective layer 8. One skilled in the art may also form the dry edge area 28 by any other suitable method within the scope of the present disclosure.

In particular example, the border 30 of the dry edge area 28 may be disposed between approximately one-half inch (0.5″) and two inches (2″) on average from the peripheral edge 10 of an end of the second section 26 of the absorbent layer 4, and more particularly disposed between approximately three-quarters inch (0.75″) and one and one-half inches (2″) on average from the peripheral edge 10, and most particularly disposed approximately one (1) inch on average from the peripheral edge 10. The border 30 may also be linear in shape and spaced apart from the peripheral edge 10 substantially evening along an entire length of the border 30, or may be disposed at an angle relative to the peripheral edge 10 and have portions that are closer or further from the peripheral edge depending on location on the length. One skilled in the art may also select other suitable widths and overall shapes for the dry edge area 28, as desired.

In certain embodiments, the dry edge area 28 may have a negligible amount of the second adhesive 18 remaining following the manufacturing process, but with no appreciable tackiness. For example, the dry edge area 28 may have either no adhesive or less than approximately 2 percent by weight relative to an original weight of the second adhesive 18 applied, i.e., less than approximately two percent by weight per unit area of the adhesive found at a remainder of the intermediate adhesive layer 6, more particularly less than approximately 1 percent by weight relative to the original weight of the second adhesive 18 applied, and most particularly less than approximately 0.2 percent by weight relative to the original weight of the second adhesive 18 applied prior to the removal process. In certain embodiments, there is no discernable amount of the second adhesive 18 remaining after the removal process. Other residual amounts of the second adhesive 18 that do not contribute to any appreciable tackiness of the dry edge area 28 are also contemplated and considered to be within the scope of the present disclosure.

In addition to advantageously facilitating the removal of the protect layer 8 prior to installation of the absorbent mat 2, described hereinabove, it should also be appreciated that the dry edge area 28 facilitates the removal of the absorbent mat 2 from the restroom floor following a period of use. In particular, the dry edge area 28 provides a surface with a negligible amount of the second adhesive 18, which allows the user to easily grip and peel the dry edge 28 upwardly from the floor of the restroom. This thereby facilitates the removal and replacement of the absorbent mat 2 with another absorbent mat 2 following the period of use.

It should be appreciated that an overall thickness of the absorbent device 2 may be selected by one skilled in the art to be suitable for use with urinals and commodes. For example, the absorbent layer 4 may be about forty-five (45) mil in thickness, and more particularly between thirty-nine (39) mil and fifty-one (51) mil in thickness. Where the intermediate adhesive layer 6 is in the laminate form, described hereinabove, the plastic sheet 14 may be about one (1) mil in thickness, and more particularly between two (2) mil and a tenth (0.1) mil in thickness. The first adhesive 16 may be about one (1) mil in thickness, and more particularly between two (2) mil and a tenth (0.1) mil in thickness. The second adhesive 18 may be about nine-tenths (0.9) mil in thickness, and more particularly between two (2) mil and a tenth (0.1) mil in thickness. Where the intermediate adhesive layer 6 is provided as the discrete layer of adhesive instead of the laminate, it should be appreciated that the thickness of the intermediate adhesive layer 6 may be about one (1) mil, and more particularly between two (2) mil and a tenth (0.1) mil in thickness. The protective layer 8 may be about three (3) mil in thickness, and more particularly between four (4) mil and two (2) mil in thickness. Overall, the absorbent mat 2 may therefore have a total thickness of about fifty (50) mil, and more particularly between fourth (40) mil and sixty (60) mil. One of ordinary skill in the art may also select other thicknesses for the absorbent layer 4, intermediate adhesive layer 6 (and its components), and the protective layer 8 within the scope of the instant disclosure.

With reference to FIGS. 14-16, the absorbent mat 2 may be provided with a crimped or compressed portion 31 of the peripheral edge 10 in order to minimize a delamination of the absorbent layer 4 and the intermediate adhesive layer 6 during storage, shipping, or end use. The portion 31 may be the entirety of the peripheral edge 10, or discrete segments of the peripheral edge 10, as desired.

In one example, as shown in FIG. 14, the crimped or compressed portion 31 of the absorbent mat 2 may be provided by a predetermined crimping pattern embossed into the peripheral edge 10. The predetermined crimping pattern may be an array or matrix of individual embossed recesses, of any desired shape. The crimped or compressed portion 31 may be thermo-embossed into the peripheral edge 10 of the absorbent mat 2 by compression between a pair of embossing rollers, where at least one of the rollers has an embossing pattern formed thereon and is heated. A skilled artisan may also select other means for forming the predetermined crimping, as desired.

In another example, as shown in FIG. 15, the crimped or compressed portion 31 of the peripheral edge 10 may include a compressed taper. The compressed taper may be provided by compression of the absorbent device 2 between a pair of embossing rollers that are each oriented on different axes of rotation, and which axes of rotation are transverse relative to each other. In this manner, the embossing rollers may result in the tapering of the crimped or compressed portion 31 of peripheral edge 10, with a thickness of the taper disposed inwardly from the peripheral edge 10 being greater than a thickness of the taper disposed at an outermost portion of the peripheral edge 10. One of ordinary skill in the art may also select other suitable means for forming the taper within the scope of the disclosure.

In a further example, as shown in FIG. 16, the crimped or compressed portion 31 of the peripheral edge 10 may include a stepped taper. Where the crimped or compressed portion 31 of the peripheral edge 10 has the stepped taper, it should be appreciated that the stepped taper may be provided with a plurality of individual steps that gradually reduce a thickness of the absorbent device 2 in a stepwise fashion, with a thickness of a step disposed inwardly from the peripheral edge 10 being greater than a thickness of a step disposed at an outermost portion of the peripheral edge 10. The compressed taper may be provided by compression of the absorbent device 2 between a pair of embossing rollers, where one of the rollers is a flat roller and the other of the rollers has the desired steps formed therein. Other suitable means for forming the stepped taper may also be employed, as desired.

It should be appreciated that the crimped or compressed portion 31 may provide between a twenty-five percent (25%) and a seventy-five percent (75%) reduction in thickness relative to a standard core thickness of the absorbent device 2. It should be understood that the reduction in total thickness of the crimped or compressed portion 31 of the peripheral edge 10 will depend on the style and degree of crimping, for example, as described hereinabove with respect to the examples of FIGS. 14-16. Likewise, it should be appreciated that any type of the crimped or compressed portion 31 and a related thickness reduction may be selected by a skilled artisan within the scope of the present disclosure.

The crimped or compressed portion 31 may be between approximately one-fourth inch (0.25″) in width and approximately one inch (1″) inch in width, and more particularly approximately one-half inch (0.5″) in width. However, other suitable widths of the crimped or compressed portion 31 of the peripheral edge 10 may also be employed, as desired.

With renewed reference to FIGS. 1-5 and 10, it should be understood that the absorbent mat 2 may be configured to be placed below a urinal 32. In this particular embodiment, the first section 24 of the absorbent layer 4 may be tapered. The taper may be provided by a first side edge 34 and a second side edge 36 that are angled generally toward one another and that are connected by a front edge 38 of the first section 24. For example, the first and second side edges 34, 36 may be oriented at an angle α of approximately thirty-three degrees (33°) relative to the longitudinal axis X, as shown in FIG. 2. Other angles for the orientation of the first and second side edges 34, 36 are also contemplated and may be selected by a skilled artisan.

Advantageously, the absorbent mat 2 having the angled first and second side edges 34, 36 connected by the front edge 38 permits the first section 24 of the absorbent mat 2 to naturally fit between the user's feet (not shown) while the user is standing at the urinal. In this manner, the absorbent mat 2 is permitted to capture splatter of liquids such as urine but is not necessary stepped upon by the user, which optimizes a durability of the absorbent mat 2 over time.

The second section 26 of the absorbent layer 4 may have a rear edge 40 that is oriented generally parallel with the front edge 38 of the first section 24. In certain embodiments, as shown in FIGS. 1-5 and 10, the dry edge area 28 may be disposed on the peripheral edge 10 adjacent to the rear edge 40 of the absorbent mat 2. Not only does the dry edge area 28 enable the user to easily remove the protective layer 8, as shown in FIG. 3, but the dry edge area 28 also facilitates the removal of the absorbent mat 2 from the floor of the restroom following the period of use.

With renewed reference to FIG. 2, as a non-limiting example, the absorbent mat 2 may have a maximum length L1 of about one foot and eight inches (1′-8″), and a maximum width W1 of one foot and six inches (1′-6″). The first section 24 may have a length L2 and the second section 26 may have a length L3. The length L2 of the first section 24, as measured from the folding axis 22 to the front edge 38, may be about nine inches (9″). The length L3 of the second section 26, as measured from the rear edge 40 to the folding axis 22, may be about eleven inches (11″). The front edge 38 may further have a width W2. In certain examples, the width W2 of the front edge 38 is less than the maximum width W1 of the absorbent mat 2. The width W2 of the front edge 38 may be about four and thirteen-sixteenths inches (4 13/16″) inches. One of ordinary skill in the art may also select other suitable dimensions and shapes for the absorbent mat 2, adapted use with urinals, within the scope of the present disclosure.

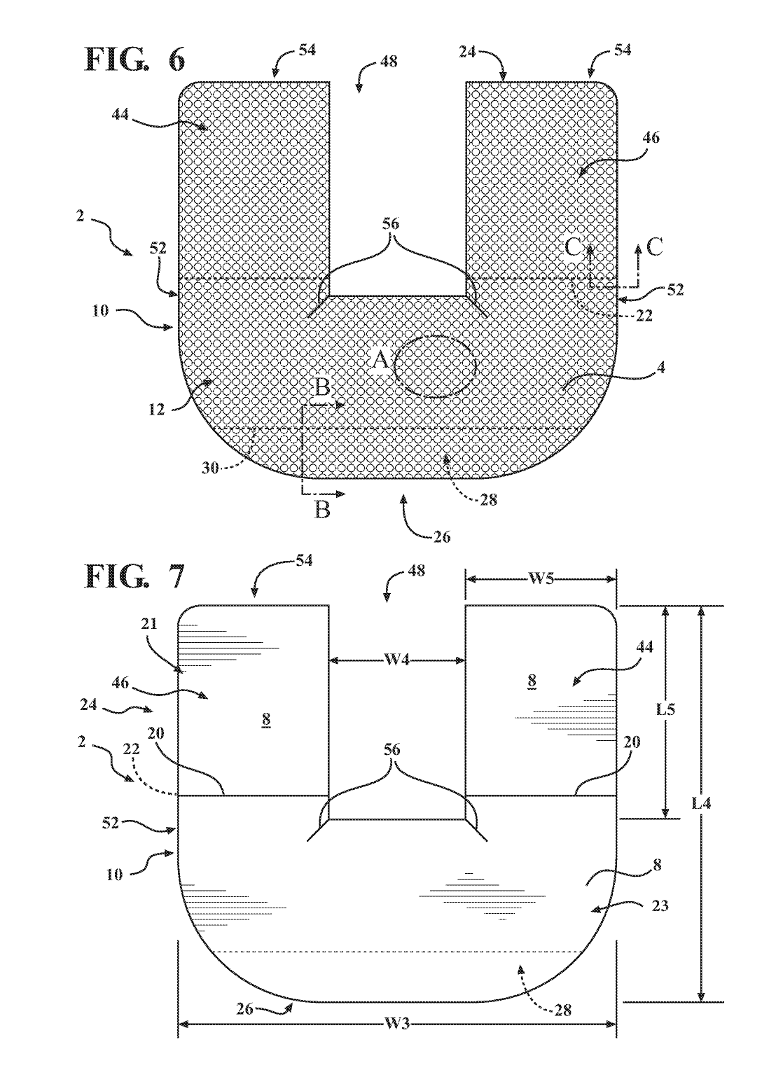

With reference to FIGS. 6-9 and 11, it should be understood that the absorbent mat 2 may be generally U-shaped and configured to be placed in front of a commode 42. In this embodiment, the first section 24 of the generally U-shaped absorbent mat 2 includes a first arm 44 and a second arm 46, which are spaced apart and connected by the second section 26. The first arm 44, the second arm 46, and the second section 26 define a gap 48 therebetween. Advantageously, the gap 48 is adapted to receive a base 50 of the commode 42, as shown in FIG. 9.

The first arm 44 and the second arm 46 may each have a proximal end 52 and a distal end 56. The proximal end 52 of each arm may be connected to the second section 26 of the absorbent layer 4, as shown in FIGS. 6-9. The first section 24 of the absorbent layer 4 may include the distal ends 56 of each arm 44, 46.

As shown in FIGS. 7-8 and 11, the split 20 may be made in the protective layer 8 on each of the first arm 44 and the second arm 46, adjacent to the proximal ends 52 of the first and second arms 44, 46. In particular embodiments, as established above, the first section 24 and the second section 26 may be divided by the folding axis 22. In this embodiment, the folding axis 22 may also be disposed adjacent the proximal ends 52 of the first arm 44 and second arm 46, as shown in FIG. 6. Due to this arrangement, the folding axis 22 may be spaced apart from a base of the gap 48, as shown in FIGS. 6-8. It should likewise be appreciated that the proximal ends 52 of the first and second arms 44, 46 may therefore form part of the second section 26 of the generally U-shaped absorbent mat 2.

With reference to FIGS. 6-9 and 11, at least one slit 56 may be formed in the second section 26. For example, the at least one slit 56 may be made through the absorbent layer 4 as well as the intermediate adhesive layer 6. In particular, the at least one slit 56 may include a pair of slits 56 that are located adjacent to the proximal ends 52 of the first arm 44 and the second arm 46. Each of the pair of slits 56 may be oriented at an angle transverse to the folding axis 22, for example. It should be appreciated that each slit 56 allows an area of the first arm 44, the second arm 46, and the second section 26 to flex upon installation of the absorbent mat 2 onto the restroom floor, so as to accommodate commode bases 50 of varying sizes.

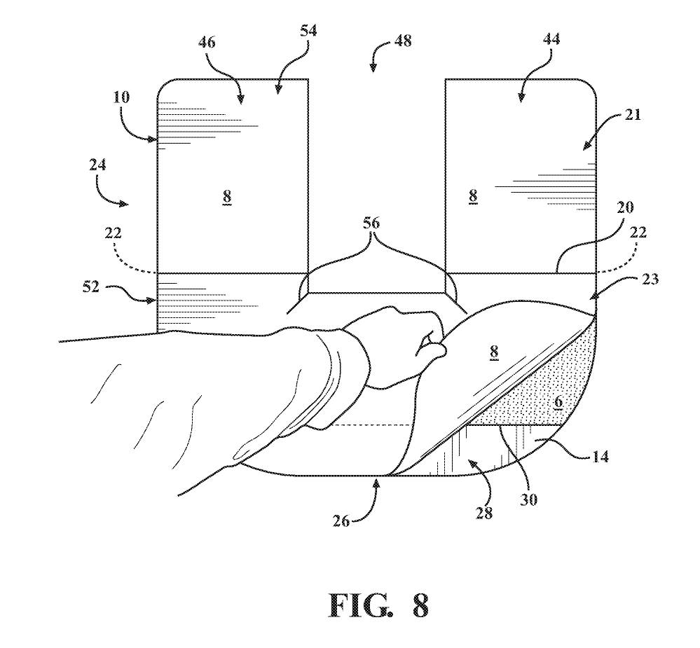

Furthermore, the dry edge area 28 may be disposed on the peripheral edge 10 at the second section 26 of the absorbent layer 4. Not only does the dry edge area 28 enable the user to easily remove the protective layer 8, as shown in FIG. 8, but the dry edge area 28 also militates against an undesirable degradation such as tearing or ripping of the absorbent mat 2 when placed in front of the commode 42. For example, in operation, the user may step on the second section 26 of the absorbent layer 4 when using the commode 42. Due to the negligible tackiness of the dry edge area 28, the dry edge area 28 is not adhered to the restroom floor. This allows the absorbent layer 4 to move as the absorbent mat 2 is disturbed by the user's feet (not shown). The free movement of the dry edge area 28 as the user's feet contact the absorbent mat 2 militates against the degradation of the absorbent layer 4 with repeated use.

With reference to FIG. 7, the absorbent mat 2 for use with commodes may have a length L4 of about one foot and seven and one-half inches in length (1′-7.5″). The absorbent mat 2 may have a width W3 of about one foot and nine and one-half inches (1′-9.5″). The gap 48 may have a width W4 of about six and three-fourth inches (6.75″) as measured from an inner edge of the first arm 44 to an inner edge of the second arm 46. The first arm 44 and second arm 46 may each have a width W5 of about seven and three-eighths inches (7.375″). The first arm 44 and the second arm 46 may each have a length L5 of about ten and one-half inches (10.5″). One of ordinary skill in the art may also select other suitable dimensions and shapes for the absorbent mat 2, adapted use with commodes, within the scope of the present disclosure.

With reference to FIGS. 10 and 11, the absorbent mat 2 may provide particular advantages associated with shipping and storage. It should be appreciated that the split 20 in the protective layer 8 facilitates the folding of the absorbent mat 2, as described hereinabove. The foldability of the absorbent mat 2 permits for the storage and transport of the absorbent mat 2 in smaller packages or boxes, which is desirable for delivery and shelving purposes.

Furthermore, the absorbent layer 4 may also be manufactured using a crease-resistant material, as established hereinabove. For example, the material of the absorbent layer 4 may be folded and stored without retaining significant creasing when unfolded, yet also be rigid enough to endure wear associated with restrooms. Thus, the foldability of the absorbent mat 2 may be performed in accordance with the present disclosure without significantly affecting the aesthetics or appearance of the absorbent mat 2 when applied to the restroom floor as described further herein.

In operation, the protective layer 8 of the absorbent mat 2 may be removed. The removal of the protective layer 8 may begin by lifting the second portion 23 of the protective layer 8 at the dry edge area 28, as shown in FIGS. 3 and 8. The first portion 21 of the protective layer 8 may then be removed by lifting the first portion 21 of the protective layer 8 adjacent to the split 20, as shown in FIG. 4. Although not shown, it should be understood that the first portions 21 of the protective layer 8 on the arms 44, 46 may likewise be removed in the embodiment where the absorbent mat 2 is intended for use with commodes.

Once the protective layer 8 is fully removed from the intermediate adhesive layer 6, the absorbent mat 2 may be secured to the restroom floor by the intermediate adhesive layer 6, either beneath the urinal 32 or adjacent to the commode 42, as shown in FIGS. 5 and 8, respectively. When the absorbent mat 2 is ready for removal, following a period of use, the user may grip the dry edge area 28 and pull the absorbent mat 2 from the restroom floor for disposal. The user may likewise replace the used absorbent mat 2 with a new absorbent mat 2 at that time.

### Examples

The preferred adhesive characteristics for the adhesive formulations used in the intermediate adhesive layer 6 of the present disclosure were determined using the standardized American Society for Testing and Material (ASTM) D3330 procedure. The ASTM D3330 procedure, published in July of 2010, is hereby incorporated by reference in its entirety. It is understood that the ASTM D3330 test procedure is equivalent to the Pressure Sensitive Tape Council (PSTC) 101 procedure, which was revised and published in 2007. The related PSTC 101 procedure is also incorporated by reference herein in its entirety.

The test method described hereinbelow was performed according to Test Method A of the ASTM D3330 procedure. Test Method A measures the peel adhesion of single-coated tapes at a 180° Angle. The Test Method A of the ASTM D3330 procedure requires a test panel measuring 50 millimeters (mm) by 125 mm (2 inches (in.) by 5 in.) and no less than 1.1 mm (0.043 in.) thick. The material of the test panel used in the experiments detailed herein below was either stainless steel (SS) or vinyl. In particular, the stainless-steel test panel conformed to Type 302 or 304 stainless steel, having a bright annealed finish. The surface roughness height of the panel was approximately 50 nanometers (nm)+/−25 nm (2.0 micro-inches (μin)+1-1.0 μin.), calculated using an arithmetical average deviation from the mean line. Panels showing stains, discoloration, or scratches were not used.

The test panel was then washed with a solvent, such as Diacetone alcohol, Methanol, Methyl ethyl ketone (MEK), n-Heptane, or Acetone. The solvent was then wiped from the panel with fresh absorbent cleaning material (e.g., wool, cotton, tissue, etc.). The panel was washed with the chosen solvent and wiped a minimum of three times. After the test panel was cleaned, it was allowed to dry for at least 10 minutes. If the cleaned test panel was not used within 10 hours, it was recleaned before testing.

Tape, having the adhesive formulation to be test, was then removed from a sample roll by freely rotating the specimen roll at a rate between 500 millimeters per second (mm/s) and 750 mm/s (20 to 30 inches per second (in./s)). At least three but no more than six outer wraps of tape from the sample roll were discarded before removing specimens for testing. Each test specimen was cut from the sample roll using two single-edged razor blades in parallel planes, a precise distance apart, to form a cutter of exact specimen's widths. For each specimen, 300 mm (12 in.)+/−0.5 mm ( 1/64 in.) of adhesive tape, having a width of 24 mm (1 in.)+/−0.5 mm ( 1/64 in.), was removed to be tested. After the tape was removed, 12 mm (0.5 in.) of adhesive tape was folded at one end, adhesive to adhesive, to form a tab. Part of the specimen without the tab, was lightly adhered to an end of the test panel. The tabbed end of the specimen was positioned loosely above the test panel to avoid contact with the panel.

The tape was rolled, mechanically or by hand, twice on the test panel in a lengthwise direction to secure the tape to the panel. If a roller was used, the roller was a steel roller having a diameter between 85 mm+/−2.5 mm (3.25+/−0.1 in.), and a width of 45 mm+/−1.5 mm (1.75+/−0.05 in.). The roller was covered with rubber approximately 6 mm (0.25 in.) thick and having a shore scale durometer hardness of 80+/−5. The surface of the roller was a true cylinder, void of any convex or concave deviations. The mass of the roller was 2040 grams (g)+/−45 g (4.5 pounds (lbs)+/−0.1 lb). The roller was moved either mechanically or by hand at the rate of 10 millimeters per second (mm/s)+/−0.5 mm/s (24 inches per minute (in./min)+/−0.5 in./min). The tape was rolled onto the panel without an entrapment of air between the adhesive and the panel.

The panel and tabbed end of the tape were then secured within the constant-rate-of-extension (CRE) tension tester. The CRE tension tester had a first clamp and a second clamp with centers oriented in the same plane. The CRE tester has a means of moving the second clamp at a uniform rate of 5.0 mm/s+/−0.2 mm/s (12 in./min+/−0.5 in./min) and a device for recording the load. The clamps of the CRE tester were parallel with the direction of the motion and were aligned to hold the specimen wholly in the same plane. The CRE tester was calibrated to an accuracy of 0.5% of full scale and the scale range used for any test was such that the mean test level falls within 20% to 80% of full scale.

Each sample was individually prepared and tested within the desired time of the trial. Each of the samples was also tested at more than one of the desired times. In a first amount of desired time, the tape was rolled onto the panel and remained adhered to the panel for twenty minutes at room temperature. In a second amount of desired time, the tape was rolled onto the panel and remained adhered to the panel for one week at room temperature. In a third amount of desired time, the tape was rolled onto the panel, and remained adhered to the panel for one week at room temperature, and then for 72 hours at 150 degrees Fahrenheit.

After the desired time of the trial, when the adhesive tape was ready to be removed, the panel was clamped in the first jaw of the CRE tension testing machine, while the tabbed free end of the tape was clamped in the movable second jaw. The moveable second jaw was operated at 5.0 mm/s+/−0.2 mm/s (12+/−0.5 in./min). The first 25 mm (1 in.) of the tape peeled from the panel at an angle of 180° was disregarded. The average force obtained during the next 50 mm (2 in.) of tape peeled from the panel over was used to obtain the adhesion values.

Multiple types of adhesives were tested using the ASTM D3330 test procedure to establish the desired level of adhesion for the absorbent mat 2. The results of these tests including the adhesion values for various adhesives are found in TABLES 1-3, shown herein below.

TABLE 1
Adhesive tested for twenty (20) minutes at room temperature (RT)

20 MIN @ RT

| Description | Adhesive | C/W | SS | Vinyl |
|---|---|---|---|---|
| 1st production | — | 15.7 g/msi | 575 psi | 572 psi |
| 2nd Production | LS92 | 16.4 g/msi | 347 psi | 444 psi |
| | LS92 | 16.3 g/msi | 467 psi | 471 psi |
| | LS92 | 17.9 g/msi | 552 psi | 533 psi |
| | LS92 | 16.6 g/msi | 661 psi | 717 psi |
| | LS92 | 15.2 g/msi | 495 psi | 520 psi |
| Trial | Custom1 | 12.5 g/msi | 446 psi | 436 psi |
| | Custom2 | 12.4 g/msi | 376 psi | 404 psi |
| | Custom3 | 17.6 g/msi | 446 psi | 425 psi |

TABLE 2
Adhesive tested for one week at room temperature (RT)

1 WK @ RT

| Description | Adhesive | C/W | SS | Vinyl |
|---|---|---|---|---|
| 1st production | — | 15.7 g/msi | 535 psi | 522 psi |
| 2nd Production | LS92 | 16.4 g/msi | 338 psi | 375 psi |
| | LS92 | 16.3 g/msi | 479 psi | 414 psi |
| | LS92 | 17.9 g/msi | 467 psi | 495 psi |
| | LS92 | 16.6 g/msi | 453 psi | 446 psi |
| | LS92 | 15.2 g/msi | 470 psi | 470 psi |
| Trial | Custom1 | 12.5 g/msi | 420 psi | 436 psi |
| | Custom2 | 12.4 g/msi | 354 psi | 381 psi |
| | Custom3 | 17.6 g/msi | 446 psi | 425 psi |

TABLE 3
Adhesive tested for one week at room temperature (RT) and then
seventy-two (72) hours at 150 Degrees Fahrenheit

1 WK @ RT +
72 hrs @ 150 F.

| Description | Adhesive | C/W | SS | Vinyl |
|---|---|---|---|---|
| 1st production | — | 15.7 g/msi | 462 psi | 407 psi |
| 2nd Production | LS92 | 16.4 g/msi | 358 psi | 391 psi |
| | LS92 | 16.3 g/msi | 384 psi | 359 psi |
| | LS92 | 17.9 g/msi | 427 psi | 436 psi |
| | LS92 | 16.6 g/msi | 381 psi | 408 psi |
| | LS92 | 15.2 g/msi | 468 psi | 454 psi |
| Trial | Custom1 | 12.5 g/msi | 415 psi | 430 psi |
| | Custom2 | 12.4 g/msi | 317 psi | 331 psi |
| | Custom3 | 17.6 g/msi | 430 psi | 429 psi |

As shown in TABLES 1-3, one of the adhesives tested was the Lab Sample Formulation 92 (LS92), which is a proprietary multi-polymer Pressure Sensitive Adhesive (PSA) formulation, developed by Polymeric Converting LLC, located in Enfield, Conn. The LS92 formulation uses building block adhesive technology and was developed by incorporating commercial ingredients from multiple sources.

The LS92 formulation employs a crosslinking co-reactant used to increase the crosslink density of acrylic resin functional groups. It was found that by increasing crosslink density, the adhesive matrix became more durable, fluid resistant, and easy to remove.

It was also discovered that by increasing the crosslinking of the acrylic resin functional groups, the measured peel strength may be increased, while the tack of the synthesized PSAs may be decreased. The increased cross linkage of acrylic resin functional groups was also found to increase a maximum value of lap shear stress. Accordingly, by increasing the cross linkage of acrylic resin functional groups, the adhesive was durable, fluid resistant, and did not leave a residue that might otherwise damage a floor surface or militate against removal of the intermediate adhesive layer 6 from the floor surface.

Custom 1 formula, shown in the TABLES 1-3, refers to the original LS92 formula with an increased coating weight (C/W). Custom 2 formula, shown in the tables below, refers to a modified adhesive formula that increased the cross linkage of the acrylic resin, while reducing the C/W. Custom 3 formula, shown in the TABLES 1-3, refers to a modified adhesive formula that increased the cross linkage of the acrylic resin, while increasing the C/W. The results of the trials were recorded according to the ASTM D3330 Method A procedure described hereinabove. The CAN of the adhesive was measured in grams per 1,000 square inches (g/msi) and the force of the adhesive was measured in pounds per square inch (psi).

The data collected and shown in TABLES 1-3 suggests a desirable adhesive strength ranging from about 300 psi to about 700 psi adhesive tested on stainless steel for 20 minutes at room temperature. A desirable adhesive strength for adhesive tested on vinyl for 20 minutes at room temperature was found to be between about 400 psi and about 750 psi. A desirable adhesive strength for adhesive tested on stainless steel for one week at room temperature was found to be between about 300 psi and about 550 psi. A desirable adhesive strength for adhesive tested on vinyl for one week at room temperature was found to be between about 350 psi and about 550 psi. A desirable adhesive strength for adhesive tested the one week at room temperature, and subsequently aged 72 hours at 150 degrees Fahrenheit, was found to be between about 300 psi and about 500 psi for both stainless steel and vinyl. It is believed that the recorded range of adhesive strength should be sufficient to adhere the absorbent mat 2 to the floor of a restroom, while not leaving an undesirable amount of residue upon removal, or otherwise damaging the floor when the absorbent mat 2 is removed after a period of use.

The preferred stiffness of the absorbent material in the absorbent layer 4 was determined using standardized test procedure ASTM D4032. The ASTM D4032 test procedure is hereby incorporated by reference in its entirety. In general, the ASTM D4032 procedure determines the stiffness of fabrics by a circular bend procedure. This test method is applicable to all types of fabrics, including woven, knitted and nonwoven fabrics of any fiber content. The test involves a plunger forcing a flat, folded swatch of fabric through an orifice in a testing platform. The maximum force required to push the fabric through the orifice is an indication of the fabric stiffness (resistance to bending).

The testing platform was a 102 mm by 102 mm by 6 mm (4 in. by 4 in. by ¼ in.) smooth-polished chrome-plated steel plate with a 38.1 mm (1.50 in.) diameter orifice. The lap edge of the orifice was at a 45° angle to a depth of 4.8 mm ( 3/16 in.). The plunger was 25.4-mm (1.00 in.) in diameter and was mounted concentric with the orifice having a 6.4 mm (0.25 in.) clearance on all sides. The bottom of the plunger was set at 3 mm (⅛ in.) above the top of the orifice plate. From this position, the downward stroke length was 57 mm (2.25 in.), and the Force-Measurement Gauge used was a dial or digital type.

The dial gauges had a maximum reading of different capacities ranging from 1 to 50 pound-force (lbf), 0.5 to 25 kilogram-force (kgf), or 5 to 200 newtons (N), with 100 graduations minimum. The digital gauge had a maximum reading “hold” feature and capacity of 100 lbf, 50 kgf, or 500 N, with 1,000 graduations minimum.

The roll of absorbent material to be tested was then removed from storage. A random number of rolls were used to test a lot sample. The first 1 m of absorbent material from the very outside of the rolls were discarded. The next 1 m of material, stretching from the end of each roll of absorbent material in the lot sample, was used for testing.

Using a specimen marking template, which marks a 102 mm by 204 mm (4.0 in. by 8.0 in.) area the lot sample, the swath of absorbent material in the lot sample was marked and cut from the lot sample. The short side of the lot sample was parallel to the machine (length) direction of the absorbent material. No lot samples were cut closer to the selvage than one tenth of the material width. A total of five test specimens were cut from staggered areas of each piece of absorbent material in the lot sample. Each specimen was laid face down and folded once to form a square of 102 mm by 102 mm (4 in. by 4 in.). After folding the specimen, the template was used to flatten the crease. Handling of specimens was kept to a minimum to avoid affecting stiffness properties. The adequately conditioned specimens were tested in the standard atmosphere for testing textiles, which is 21° C.+/−1° C. (70° F.+/−2° F.) and 65%+1-2% relative humidity.

A gauge was selected with a capacity in which results would fall within 15% to 100% of dial gauge force or 1.5% to 100% of the digital gauge force. The tester was set on a flat surface with the dial gauge at eye level. The tester plunger speed control was checked for a full stroke length.

The air pressure control to the actuator was set at 324 pascal (kPa) (47 psi). Using a stop-watch, the pneumatics were adjusted to provide a plunger speed of 1.7 s+/−0.15 s under no load conditions. A stop-watch was used to establish and confirm a plunger speed of 1.7 s+1-0.3 s. The specimen was centered on the orifice platform below the plunger. The gauge was checked to be at zero and was adjusted, if necessary. The maximum force reading switch was set.

Each folded specimen was placed over the orifice and the plunger was actuated for the full stroke length. The maximum force reading to nearest gauge graduation was recorded. Each individual specimen readings were averaged and rounded to the nearest gauge increment.

After performing the ASTM D4032 standardized test on the Magic Dragon™ (MD) 100-series nonwoven material of the absorbent layer 4, a stiffness value of between approximately 4.0 kgf and approximately 8.0 kgf was established. The Magic Dragon™ (MD) 100-series nonwoven material was also observed to have no or minimal visual creases remaining after testing. The stiffness value of the Magic Dragon™ (MD) 100-series nonwoven material is also comparatively lower than stiffness values of other known absorbent materials, which have been observed to exhibit visible creases or wrinkles upon folding and have stiffness values greater than 25.0 kgf. It is therefore believed that having a stiffness value of less than 25.0 kgf, and more preferably approximately 4.0 kgf to approximately 8.0 kgf, contributes to a minimization of crease or wrinkle formation after folding, and is therefore desirable. The absence of visible creases or wrinkles after folding is a desirable trait for the absorbent mat 2 of the present disclosure. In particular, the lack of a crease allows the absorbent mat 2 to be folded while shipped and stored, yet remain aesthetically pleasing when ready for use.

Advantageously, the absorbent mat 2 of the present disclosure is inexpensive, foldable, easy to install, and easy to remove. The absorbent mat 2 has also been found to exhibit minimal creasing or wrinkling after being folded, as described hereinabove.

While certain representative embodiments and details have been shown for purposes of illustrating the invention, it will be apparent to those skilled in the art that various changes may be made without departing from the scope of the disclosure, which is further described in the following appended claims.

What is claimed is:

1. An absorbent mat, comprising:
an absorbent layer with a first section and a second section, and at least one folding axis that separates the first section from the second section, the absorbent layer further having a peripheral free edge that bounds the first section and the second section;
a protective layer; and
an intermediate adhesive layer affixed to the absorbent layer and disposed between the absorbent layer and the protective layer, the protective layer removably attached to the intermediate adhesive layer, the intermediate adhesive layer further having a dry edge area disposed adjacent the peripheral free edge of the absorbent layer, there being no significant adhesion between the dry edge area and the protective layer.

2. The absorbent mat of claim 1, wherein the protective layer has at least one split formed therethrough.

3. The absorbent mat of claim 2, wherein the split defines a plurality of protective portions of the protective layer, and each of the protective portions is individually removably attached to the intermediate adhesive layer.

4. The absorbent mat of claim 2, wherein the split is oriented along the folding axis.

5. The absorbent mat of claim 1, wherein the dry edge area is disposed immediately adjacent to the peripheral free edge on the second section of the intermediate adhesive layer.

6. The absorbent mat of claim 5, wherein the dry edge area has either no adhesive or less than approximately two percent by weight per unit area of the adhesive found at a remainder of the intermediate adhesive layer.

7. The absorbent mat of claim 1, wherein the intermediate adhesive layer is a laminate having a plastic sheet disposed between a first adhesive and a second adhesive.

8. The absorbent mat of claim 7, wherein the plastic sheet is polyethylene terephthalate and at least one of the first adhesive and the second adhesive is an acrylic emulsion adhesive.

9. The absorbent mat of claim 1, wherein the intermediate adhesive layer exhibits an adhesive strength between approximately 300 psi and about 700 psi on stainless steel, where the intermediate adhesive layer is adhered to the stainless steel for about 20 minutes at room temperature, and between about 400 psi and about 750 psi on vinyl, where the intermediate adhesive layer is adhered to the stainless steel for about 20 minutes at room temperature, wherein the adhesive strength is determined according to a standardized test procedure ASTM D3330.

10. The absorbent mat of claim 1, wherein the absorbent layer is a nonwoven textile material including rayon, polyester and a binding agent.

11. The absorbent mat of claim 1, wherein the absorbent layer has a stiffness value between approximately 4.0 kgf and approximately 8.0 kgf, as established through a standardized test procedure ASTM D4032.

12. The absorbent mat of claim 1, wherein a portion of the free peripheral edge of the absorbent layer is crimped or compressed together with the intermediate adhesive layer.

13. The absorbent mat of claim 1, wherein the absorbent layer is generally U-shaped and has a first arm and a second arm.

14. The absorbent mat of claim 13, wherein the first arm is spaced apart from the second arm, forming a gap therebetween, and the gap is adapted to receive a base of a commode.

15. The absorbent mat of claim 14, wherein the second section of the absorbent layer has a first slit and a second slit, and each of the first slit and the second slit are oriented at an angle transverse to the folding axis.

16. The absorbent mat of claim 1, wherein the absorbent mat is provided as one of a plurality of absorbent mats in a roll that can be cut by a user to a desired size or length.

17. The absorbent mat of claim 1, wherein the peripheral free edge of the first section of the absorbent layer has a first side edge, a second side edge, and a front edge, and the first side edge is angled generally toward the second side edge, the second side edge is angled generally toward the first side edge, and the front edge connects the first side edge to the second side edge.

18. The absorbent mat of claim 17, wherein the peripheral free edge of the second section has a rear edge, and the dry edge area of the intermediate adhesive layer is disposed immediately adjacent to the rear edge.

19. An absorbent mat for use with a urinal, comprising:
an absorbent layer with a first section and a second section, and at least one folding axis that separates the first section from the second section, the absorbent layer further having a peripheral free edge that bounds the first section and the second section, the peripheral free edge of the first section having a first side edge, a second side edge, and a front edge, the first side edge angled generally toward the second side edge and the second side edge angled generally toward the first side edge, the front edge connecting the first side edge to the second side edge, and the peripheral free edge of the second section having a rear edge spaced apart from and disposed opposite on the absorbent layer from the front edge;
a protective layer; and
an intermediate adhesive layer affixed to the absorbent layer, the protective layer removably attached to the intermediate adhesive layer, the protective layer having at least one split that defines a plurality of protective portions of the protective layer, and each of the protective portions removably attached to the intermediate adhesive layer, the intermediate adhesive layer further having a dry edge area disposed immediately adjacent to the rear edge of the second section of the absorbent layer, there being no significant adhesion between the dry edge area and the protective layer, and
wherein the absorbent mat is configured to be placed adjacent to the urinal, and the second section of the absorbent layer is configured to be placed beneath the urinal.

20. An absorbent mat for use with a commode, comprising:
an absorbent layer with a first section and a second section, and at least one folding axis that separates the first section from the second section, the absorbent layer further having a peripheral free edge that bounds the first section and the second section, the peripheral free edge of the first section having a front edge, and the peripheral free edge of the second section having a rear edge spaced apart from and disposed opposite on the absorbent layer from the front edge, the absorbent layer being generally U-shaped with the first section including a first arm and a second arm, the first arm spaced apart from the second arm and forming a gap therebetween,
a protective layer; and
an intermediate adhesive layer affixed to the absorbent layer, the protective layer removably attached to the intermediate adhesive layer, the protective layer having at least one split that defines a plurality of protective portions of the protective layer, and each of the protective portions removably attached to the intermediate adhesive layer, the intermediate adhesive layer further having a dry edge area disposed immediately adjacent to the rear edge of the second section of the absorbent layer, there being no significant adhesion between the dry edge area and the protective layer, and
wherein the absorbent mat is configured to be placed adjacent to the commode, the second section of the absorbent layer is configured to be placed in front of a base of the commode and the gap is configured to receive the base of the commode.
